(19) United States
(12) Patent Application Publication
(10) Pub. No.: US 2025/0389943 A1
(43) Pub. Date: Dec. 25, 2025

(54) METHOD AND DEVICE FOR ACHIEVING SUPER-RESOLUTION MICROSCOPIC IMAGING BY SUPER-OSCILLATORY DIFFRACTIVE NEURAL NETWORK

(71) Applicant: Tsinghua University, Beijing (CN)

(72) Inventors: Xing LIN, Beijing (CN); Hang Chen, Beijing (CN); Haiou Zhang, Beijing (CN)

(73) Assignee: Tsinghua University, Beijing (CN)

(21) Appl. No.: 19/239,517

(22) Filed: Jun. 16, 2025

(30) Foreign Application Priority Data
Jun. 20, 2024 (CN) 202410804549.X

(51) Int. Cl. G02B 21/36; G02B 23/24; G06T 5/60

(52) U.S. Cl. CPC G02B 21/365; G02B 23/2484; G06T 5/60; G06T 2207/20081; G06T 2207/20084

(57) ABSTRACT

A method and device achieving super-resolution microscopic imaging by a super-oscillatory diffractive neural network. By acquiring three-dimensional optical field constraint conditions, training a super-oscillatory diffractive neural network based on the three-dimensional optical field constraint conditions to optimize step heights of diffractive units in the super-oscillatory diffractive neural network, to minimize a difference of a light intensity distribution of a super-oscillatory focal spot and a light intensity distribution of side lobes generated by the super-oscillatory diffractive neural network from a light intensity distribution of an ideal output optical field, and/or to minimize light intensity outside a super-oscillatory region, and modulating incident light based on the trained super-oscillatory diffractive neural network to generate a super-oscillation effect in a three-dimensional space to acquire a super-resolution microscopic imaging result.

### CROSS-REFERENCE TO RELATED APPLICATION

The present application claims priority under 35 U.S.C. § 119 (a) to Chinese Patent Application No. 202410804549.X filed with National Intellectual Property Administration, PRC, on Jun. 20, 2024, entitled “Method and Device for achieving super-resolution microscopic imaging by a super-oscillatory diffractive neural network”. All the above referenced priority document is incorporated herein by reference in its entirety.

### TECHNICAL FIELD

The present disclosure relates to the field of optical technology, in particular to a method and a device for achieving super-resolution microscopic imaging by a super-oscillatory diffractive neural network.

### BACKGROUND

The Abbe-Rayleigh diffraction limit of conventional optical equipment has always been a critical bottleneck to the imaging technology for micro-/nano-scale objects. Near-field microscopic imaging methods, such as Scanning Near-field Optical Microscopy (SNOM), capture evanescent waves by placing a probe or light-sensitive material extremely close to the object to achieve nanoscale resolution, but these methods cannot detect the interiors of biological samples or encapsulated micro-/nano-structures. Far-field microscopic imaging technology is not restricted by the above bottleneck. Some typical far-field microscopic imaging techniques, such as Single-molecule Localization (SML) microscopy or Stimulated Emission Depletion (STED), have demonstrated the possibility of nanoscale imaging without capturing evanescent waves. However, SML microscopy and STED typically require intense light beams to excite, deplete, or bleach fluorophores in a sample under test, which will accumulate phototoxicity in living samples.

In view of the above, currently, far-field super-resolution imaging beyond the diffraction limit is generally achieved through the phenomenon of optical super-oscillation. Optical super-oscillation refers to the rapid sub-wavelength spatial variations of light intensity and phase that occur in complex electromagnetic fields formed by the precise interference of coherent light, which provide an advanced method for far-field super-resolution imaging beyond the diffraction limit. To generate optical super-oscillation, complex lens design methods and optimized design methods for Fresnel zone plate (FZP) have been proposed by the prior art. However, the above technical solutions still have limitations, including:
(1) small fields of view resulting from strong side lobes;
(2) short working distances;
(3) limited depth-of-focus (DoF); or
(4) chromatic aberration caused by wavelength-dependent phase delay.

The above technical challenges significantly limit the practical application of the super-oscillation phenomenon.

### SUMMARY

In view of the above, the present disclosure provides a method and a device for achieving super-resolution microscopic imaging by a super-oscillatory diffractive neural network, which may modulate an optical field in a three-dimensional space by optimizing optical coefficients of a diffractive unit in the super-oscillatory diffractive neural network, and which may generate a super-oscillatory focal spot with a large field of view with zero side lobes, a long working distance, a long depth of field, and achromatism in any local area, thereby achieving high-performance super-resolution microscopic imaging.

According to one aspect of the present disclosure, there is provided a method for achieving super-resolution microscopic imaging by a super-oscillatory diffractive neural network, the method comprising:

acquiring three-dimensional optical field constraint conditions, wherein the three-dimensional optical field constraint conditions include a first constraint condition and/or a second constraint condition, the first constraint condition being configured to indicate that within a desired three-dimensional optical field spatial range, a difference of a light intensity distribution of a super-oscillatory focal spot and a light intensity distribution of side lobes from a light intensity distribution of an ideal output optical field is minimized, and the second constraint condition being configured to indicate that within the desired three-dimensional optical field spatial range, light intensity outside a super-oscillatory region is minimized;

training a super-oscillatory diffractive neural network based on the three-dimensional optical field constraint conditions to optimize a step height of a diffractive unit in the super-oscillatory diffractive neural network to acquire a trained super-oscillatory diffractive neural network, wherein the super-oscillatory diffractive neural network comprises at least one diffractive layer, each of which comprises a plurality of diffractive units; and

modulating incident light based on the trained super-oscillatory diffractive neural network to generate a super-oscillation effect in a three-dimensional space to acquire a super-resolution microscopic imaging result.

In one possible implementation, the three-dimensional optical field constraint conditions include the first constraint condition and the second constraint condition, wherein the expression of the three-dimensional optical field constraint conditions includes:

$${min}_{Δ H} ( {\sum }_{{z}_{i} ∈ [ f - Δ f , f + Δ f ]} \{ {( ( {I}_{( {x}_{i} , {y}_{i} , {z}_{i} )} + {I}_{{\sum }_{j} ( {x}_{j} , {y}_{j} , {z}_{\text{?}} )} ) - {I}_{target} )}^{2} + MSE ( {I}_{( x , y , z ) ∉ ( {x}_{i} , {y}_{i} , {z}_{\text{?}} )} ) \} )$$

$$\text{?} \text{indicates text missing or illegible when filed}$$

where min( ) represents a minimization function, ΔH represents a step height distribution of the diffractive units, [f−Δf, f+Δf] represents the three-dimensional optical field spatial range, f represents a focal length, zᵢ represents a distance between the diffractive layer and an output plane, I(xᵢ, yᵢ, zᵢ) represents a light intensity distribution of a super-oscillatory focal spot at three-dimensional spatial coordinates (xᵢ, yᵢ, zᵢ), I_{Σj}(xᵢ, yᵢ, zᵢ) represents a light intensity distribution of side lobes at a set Σⱼ(xᵢ, yᵢ, zᵢ) of the three-dimensional spatial coordinates, I_{target} represents an ideal light intensity distribution of the super-oscillatory focal spot, MSE( ) represents a mean square error function, and I_{(x, y, z)∉}(xᵢ, yᵢ, zᵢ) represents light intensity outside the super-oscillatory region.

In one possible implementation, a value of the Δf is not equal to 0.

According to another aspect of the present disclosure, there is provided a device for achieving super-resolution microscopic imaging by a super-oscillatory diffractive neural network, the device comprising:

a super-oscillatory diffractive neural network configured to modulate incident light to generate a super-oscillation effect in a three-dimensional space, wherein the super-oscillatory diffractive neural network comprises at least one diffractive layer, each of which comprises a plurality of diffractive units; step heights of the diffractive units are acquired from training based on preset three-dimensional optical field constraint conditions, the three-dimensional optical field constraint conditions including a first constraint condition and/or a second constraint condition, the first constraint condition being configured to indicate that within a desired three-dimensional optical field spatial range, a difference of a light intensity distribution of a super-oscillatory focal spot and a light intensity distribution of side lobes from a light intensity distribution of an ideal output optical field is minimized, and the second constraint condition being configured to indicate that within the desired three-dimensional optical field spatial range, light intensity outside a super-oscillatory region is minimized.

In one possible implementation, the number of the diffractive layers is one.

In one possible implementation, the number of the diffractive units in one diffractive layer is greater than or equal to 500×500.

In one possible implementation, the size of the diffractive units is λ/2×λ/2, wherein λ represents a wavelength of the incident light.

In one possible implementation, the device for super-resolution microscopic imaging comprises a reconfigurable apparatus comprising a plurality of the super-oscillatory diffractive neural networks, wherein the three-dimensional spatial coordinates of the super-oscillatory focal spots formed by different super-oscillatory diffractive neural networks are different.

In one possible implementation, the device for super-resolution microscopic imaging comprises an endoscope. Accordingly, the device further comprises:

an optical fiber configured to transmit incident light generated by a light source, the super-oscillatory diffractive neural network being provided in the optical fiber;

a reflective structure arranged at an output end of the super-oscillatory diffractive neural network to reflect an output optical field of the super-oscillatory diffractive neural network to acquire a reflected signal of a super-oscillatory focal spot; and

a detection structure arranged on an input end side at an exit end of the optical fiber to detect the reflected signal on a detection plane to acquire an imaging result.

According to another aspect of the present disclosure, there is provided a device for achieving super-resolution microscopic imaging by a super-oscillatory diffractive neural network, comprising: a processor; and a storage for storing processor executable instructions, wherein the processor is configured to, when executing the instructions stored in the storage, implement the method described above.

According to another aspect of the present disclosure, there is provided a non-transitory computer readable storage medium having computer program instructions stored thereon, wherein the computer program instructions, when executed by a processor, implement the method described above.

According to another aspect of the present disclosure, there is provided a computer program product comprising computer readable code, or a non-transitory computer readable storage medium carrying computer readable code, wherein when the computer readable code runs in a processor of an electronic apparatus, the processor of the electronic apparatus carries out the method described above.

The trained super-oscillatory diffractive neural network is acquired by acquiring the three-dimensional optical field constraint conditions to train the super-oscillatory diffractive neural network to optimize the step heights of the diffractive units in the super-oscillatory diffractive neural network. Based on the trained super-oscillatory diffractive neural network, the incident light is modulated to generate the super-oscillation effect in the three-dimensional space to acquire the super-resolution microscopic imaging results. This may achieve the effect of generating a super-oscillatory focal spot with a large field of view with zero side lobes, a long working distance, a long depth of field, and achromatism in any local area, and may solve the technical problems of small fields of view resulting from strong side lobes, short working distances, limited depth-of-focus, and chromatic aberration caused by wavelength-dependent phase delay existing in the conventional optical super-oscillation phenomenon generation methods, thereby improving the effect of super-resolution microscopic imaging.

Other features and aspects of the present disclosure will become apparent from the following detailed description of exemplary embodiments with reference to the drawings.

### BRIEF DESCRIPTION OF THE DRAWINGS

The drawings, which are incorporated in and constitute a part of the description, together with the description, illustrate exemplary embodiments, features, and aspects of the present disclosure, and serve to explain the principle of the present disclosure.

FIG. 1 is a schematic diagram of a super-oscillatory focal spot and a side lobe in a conventional super-oscillatory imaging method according to an embodiment of the present disclosure.

FIG. 2 is a flow chart of a method for achieving super-resolution microscopic imaging by a super-oscillatory diffractive neural network according to an embodiment of the present disclosure.

FIG. 3 is a schematic diagram of a network structure of a super-oscillatory diffractive neural network according to an embodiment of the present disclosure.

FIG. 4 is a schematic diagram of a super-resolution microscopic imaging result acquired by a super-oscillatory diffractive neural network according to an embodiment of the present disclosure.

FIG. 5 is a schematic diagram of a super-oscillatory focal spot and full widths at half maximum (FWHMs) at Δf=0 according to an embodiment of the present disclosure.

FIG. 6 is a schematic diagram of side lobes produced by four out-of-focus planes at Δf=0 according to an embodiment of the present disclosure.

FIG. 7 is a schematic diagram of generation of a super-oscillatory light needle at Δf=6Δf′ according to an embodiment of the present disclosure.

FIG. 8 is a schematic diagram of slices of a super-oscillatory light needle according to an embodiment of the present disclosure.

FIG. 9 is a schematic diagram of FWHMs corresponding to the slices of the super-oscillatory light needle according to an embodiment of the present disclosure.

FIG. 10 is a schematic diagram of super-oscillatory focal spots and FWHMs generated by multi-wavelength incident light according to an embodiment of the present disclosure.

FIG. 11 is a schematic diagram of 3×5 super-oscillatory focal spot arrays and FWHMs generated by multi-wavelength incident light according to an embodiment of the present disclosure.

FIG. 12 is a schematic diagram of a super-oscillatory focal spot array forming a “THU” pattern and FWHMs according to an embodiment of the present disclosure.

FIG. 13 is a schematic diagram of a super-oscillatory focal spot array forming a heart-shaped pattern and an FWHM according to an embodiment of the present disclosure.

FIG. 14 is a structural schematic diagram of a device for achieving super-resolution microscopic imaging by a super-oscillatory diffractive neural network according to an embodiment of the present disclosure.

FIG. 15 is a structural schematic diagram of a single-focus SODNN and a multi-focus SODNN according to an embodiment of the present disclosure.

FIG. 16 is a schematic diagram of a numerical analysis result and an experimental measurement result of a single-focus SODNN according to an embodiment of the present disclosure.

FIG. 17 is a schematic diagram of a numerical analysis result and an experimental measurement result of a 2×2 focused SODNN according to an embodiment of the present disclosure.

FIG. 18 is a schematic diagram of FWHMs acquired from numerical analysis results and experimental measurement results of a single-focus super-oscillatory focal spot and a 2×2 multi-focus super-oscillatory focal spot array according to an embodiment of the present disclosure.

FIG. 19 is a schematic diagram of imaging a resolution test plate by an Olympus objective lens and imaging a resolution test plate by an SODNN according to an embodiment of the present disclosure.

FIG. 20 is a schematic diagram of a comparison between a device for achieving super-resolution microscopic imaging by a super-oscillatory diffractive neural network according to an embodiment of the present disclosure and a conventional super-oscillatory lens.

FIG. 21 is a schematic diagram of network performance variation with different numbers of diffractive units in one diffractive layer according to an embodiment of the present disclosure.

FIG. 22 is a schematic diagram of network performance variation with different diffractive layers when the number of diffractive units is fixed at 200×200 and the size of the diffractive units is fixed at λ/2×λ/2 according to an embodiment of the present disclosure.

FIG. 23 is a schematic diagram of network performance variation with different diffractive layers when the number of diffractive units is fixed at 300×300 and the size of the diffractive units is fixed at λ/2×λ/2 according to an embodiment of the present disclosure.

FIG. 24 is a schematic diagram of network performance variation when the number of diffractive units is fixed at 300×300, the number of diffractive layers is fixed at one, and the sizes of the diffractive units are set to λ/2×λ/2, λ×λ, 2λ×2λ, and 4λ×4λ, respectively, according to an embodiment of the present disclosure.

FIG. 25 is a schematic diagram of results acquired by using a series of SODNNs to perform raster scanning at arbitrary positions across an entire detection plane for imaging, according to an embodiment of the present disclosure.

FIG. 26 is a schematic diagram of a device for achieving super-resolution microscopic imaging by a super-oscillatory diffractive neural network according to another embodiment of the present disclosure.

FIG. 27 is a schematic diagram of imaging results of an endoscope integrated with an SODNN, demonstrating strong and weak reflections, according to an embodiment of the present disclosure.

FIG. 28 is a schematic diagram of an imaging result of imaging a resolution test plate by an endoscope integrated with an SODNN according to an embodiment of the present disclosure.

FIG. 29 is a block diagram of a device for achieving super-resolution microscopic imaging by a super-oscillatory diffractive neural network according to an embodiment of the present disclosure.

### DETAILED DESCRIPTION

Various exemplary embodiments, features and aspects of the present disclosure will be explained in detail below with reference to the drawings. In the drawings, the same reference signs denote elements with the same or similar functions. Although various aspects of the embodiments are shown in the drawings, unless otherwise specified, the drawings are not necessarily drawn to scale.

The word “exemplary” used here means “serving as an example, embodiment or illustration”. Any embodiment described here as “exemplary” is not necessarily to be interpreted as superior to or better than other embodiments.

In addition, to better explain the present disclosure, numerous details are given in the following embodiments. It is appreciated by those skilled in the art that the present disclosure can still be implemented without some specific details. In some embodiments, methods, means, elements and circuits well known to those skilled in the art are not described in detail in order to highlight the gist of the present disclosure.

The general principle of super-oscillatory imaging is to generate a super-oscillatory optical field and irradiate it onto an object to be imaged. The microstructure of the object interacts with the optical field, producing scattering or reflection. These scattered or reflected light waves carry sub-wavelength scale information about the object. The light waves after interaction with the super-oscillatory optical field are collected and detected. The collected light waves are used to reconstruct an image of the object. Through the above steps, super-resolution imaging of the object may be achieved.

A Super-oscillatory Diffractive Neural Network (SODNN) is an optical element that may be used in super-oscillatory imaging for specific tasks such as generating specific optical fields, controlling focal points, collecting reflected light waves, and generating image data. Deep learning may be employed for the inverse design of the SODNN to tailor it to meet the application requirements.

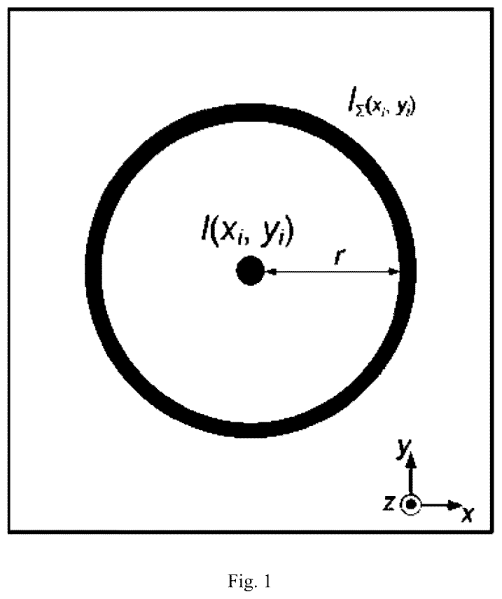

Conventional super-oscillatory imaging methods include performing system optimization under the constraint of two-dimensional optical fields through one-dimensional modulation elements or two-dimensional modulation elements with binary phase modulation. However, this approach may only achieve optimization in a two-dimensional optical field. Moreover, the number of elements that may be modulated by the one-dimensional modulation element is limited, and the two-dimensional modulation element may only perform binary phase modulation. These limitations give rise to the issue of restricted performance optimization. For example, conventional super-oscillatory imaging methods may be implemented by a one-dimensional pinhole array or a two-dimensional zone plate. In this case, it is necessary to first use the prolate spheroidal function or the Strehl ratio as an optimization function for a model. Subsequently, a phase distribution of a super-oscillatory lens is acquired through joint optimization based on a full width at half maximum (FWHM) of a super-oscillatory focal spot I(xᵢ, yᵢ) at a two-dimensional position (xᵢ, yᵢ) and side lobe intensity I_{Σ}(xⱼ,yⱼ) at a two-dimensional position Σ(xⱼ, yⱼ). As shown in FIG. 1, a distance r in FIG. 1 represents a distance between the super-oscillatory focal spot and the side lobe.

However, due to the complexity of manufacturing and control, an actual super-oscillatory one-dimensional pinhole array may only contain a limited number of modulation elements, and an actual two-dimensional zone plate may only achieve phase modulation of 0 or 1, resulting in poor optimization outcomes. Additionally, the above optimization process requires a complex formula decomposition process, which further restricts the design flexibility of the method.

In view of the above, the present disclosure provides a super-oscillatory diffractive neural network (SODNN), which may achieve super-resolution spatial resolution and be used to achieve imaging detection beyond the diffraction limit. In other words, the SODNN may generate an optical super-oscillation phenomenon in a three-dimensional space to achieve super-resolution microscopic imaging beyond the diffraction limit. By constructing a large-scale SODNN and optimizing optical coefficients of superimposed diffractive layers to modulate an optical field in a three-dimensional space, the present disclosure may generate a super-oscillatory focal spot with a large field of view with zero side lobes, a long working distance, a long depth of field, and achromatism in any local area, thereby achieving high-performance super-resolution microscopic imaging. Under such circumstances, the super-resolution microscopic imaging is no longer limited by the number of modulation elements, and it is possible to generate an optical super-oscillation effect in any three-dimensional space. In addition, the training of the SODNN does not require a complex formula decomposition process, which may ensure the flexibility of the super-resolution microscopic imaging method.

Hereinafter, the method for achieving super-resolution microscopic imaging by a super-oscillatory diffractive neural network will be described in detail. This embodiment takes the case where the method for super-resolution microscopic imaging is applied to an electronic apparatus with computing capability as an example for explanation. The electronic apparatus includes, but is not limited to, a computer or a server, and the like, and the implementation mode of the electronic apparatus is not limited in this embodiment. For example, the method is used on a computer equipped with an Intel Xeon Gold 6226R CPU at 2.90 GHz with 16 cores and 24 Nvidia GTX-3090Ti GPUs. In actual implementation, the models of the CPU and GPU in the electronic apparatus may be other models, and the number of the CPU and GPU may be more or less. This embodiment does not limit the application scenarios of the method for super-resolution microscopic imaging.

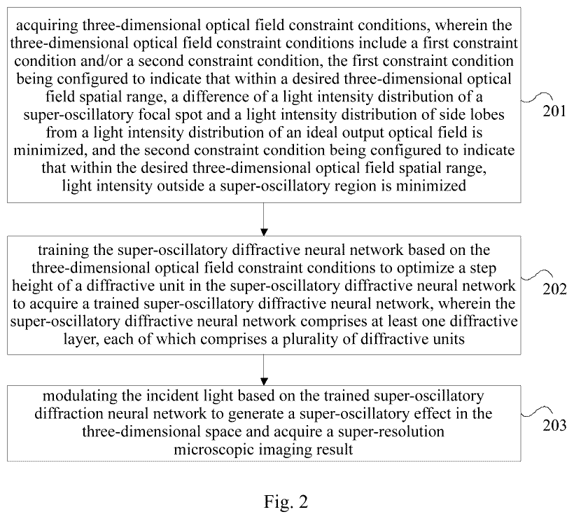

FIG. 2 is a flow chart of a method for achieving super-resolution microscopic imaging by a super-oscillatory diffractive neural network according to an embodiment of the present disclosure. As shown in FIG. 2, the method comprises:

Step 201: acquiring three-dimensional optical field constraint conditions, wherein the three-dimensional optical field constraint conditions include a first constraint condition and/or a second constraint condition, the first constraint condition to indicate that within a desired three-dimensional optical field spatial range, a difference between a light intensity distribution of a super-oscillatory focal spot and a light intensity distribution of side lobes from a light intensity distribution of an ideal output optical field is minimized, and the second constraint condition to indicate that within the desired three-dimensional optical field spatial range, light intensity outside a super-oscillatory region is minimized.

The three-dimensional optical field spatial range refers to a range formed by a distance zᵢ between a detection plane where the output optical field is located and the SODNN. In this embodiment, the detection plane refers to a plane for receiving light output from the SODNN in an optical system. Generally, a detector captures the light output from the SODNN on the detection plane. For example, if a user expects to form a super-oscillatory focal spot within zᵢ ∈[f−Δf, f+Δf], the three-dimensional optical field spatial range is [f−Δf, f+Δf], where f represents a focal length and Δf represents a preset constant smaller than f. At this time, a super-oscillatory light needle with a long depth of field (i.e., 2Δf) may be acquired. The super-oscillatory light needle is a needle-like optical field with a certain depth of focus (e.g., 2Δf) generated by utilizing the super-oscillation phenomenon.

The ideal output optical field refers to a large field-of-view output optical field with substantially zero side lobes. In this case, by suppressing the light intensity distribution of the slid lobes through the three-dimensional optical field constraint conditions, the output optical field acquired by actual modulation by the SODNN may infinitely approach the ideal output optical field, that is, a large field-of-view output optical field with substantially zero side lobes may be acquired. The “substantially zero” means that the side lobes are zero, or that the intensity of the side lobes is slightly greater than zero but smaller than the intensity of the side lobes in the imaging results acquired by conventional super-oscillatory imaging methods.

The super-oscillatory region refers to a region where the super-oscillatory focal spot is formed. Optionally, depending on different imaging requirements, the number of super-oscillatory regions may be one or more, and different super-oscillatory regions are configured to form different super-oscillatory focal spots.

Optionally, depending on different super-resolution microscopic imaging scenarios of the super-oscillatory diffractive neural network, the specific parameters of the light intensity distribution of the ideal output optical field, the three-dimensional optical field spatial range, and the three-dimensional spatial coordinates of the super-oscillatory region in the three-dimensional optical field constraint conditions may vary. These parameters may be set based on user requirements. For example, the value of Δf, the three-dimensional spatial coordinates of the super-oscillatory region, and the like may be set based on user requirements. This embodiment does not limit the specific content of the parameters in the three-dimensional optical field constraint conditions.

Optionally, in this embodiment, the coordinate system of the three-dimensional spatial coordinates may take the center of the SODNN as the origin, the detection plane as the plane formed by the x-axis and the y-axis, and the axis perpendicular to the detection plane as the z-axis; or, the three-dimensional spatial coordinates may take the focal point as the origin, the plane where the detection plane is located as the plane formed by the x-axis and the y-axis, and the axis perpendicular to the detection plane as the z-axis. In other embodiments, the coordinate system of the three-dimensional spatial coordinates may be established with any point in the three-dimensional space as the origin. This embodiment does not limit the establishment method of the three-dimensional spatial coordinate system.

Step 202: training the super-oscillatory diffractive neural network based on the three-dimensional optical field constraint conditions to optimize a step height of a diffractive unit in the super-oscillatory diffractive neural network, to acquire a trained super-oscillatory diffractive neural network, wherein the super-oscillatory diffractive neural network comprises at least one diffractive layer, each of which comprises a plurality of diffractive units.

In this embodiment, the super-oscillatory diffractive neural network refers to a mathematical model running in an electronic apparatus, and this mathematical model is configured to simulate the optical diffraction performance of the physical super-oscillatory diffractive neural network.

The diffractive unit is a diffractive optical element (DOE) for performing specific phase modulation and intensity modulation on the incident light. The plurality of diffractive units in the diffractive layer are distributed in an array to simulate the neuron connections and the weight distribution in an artificial neural network and achieve the super-oscillation effect. By way of example, the diffractive units are in an n×n array, wherein n is an integer greater than 1. In other embodiments, the number of rows and columns of the array of the diffractive units may be different. This embodiment does not limit the distribution mode of the diffractive units.

The SODNN achieves optical interconnection through the diffractive layer and utilizes an imaging sample or a biosensor located after the super-oscillatory diffractive neural network to achieve nonlinear functional performance, so as to perform photoelectric nonlinear transformation on the output optical field and acquire a super-resolution microscopic imaging result.

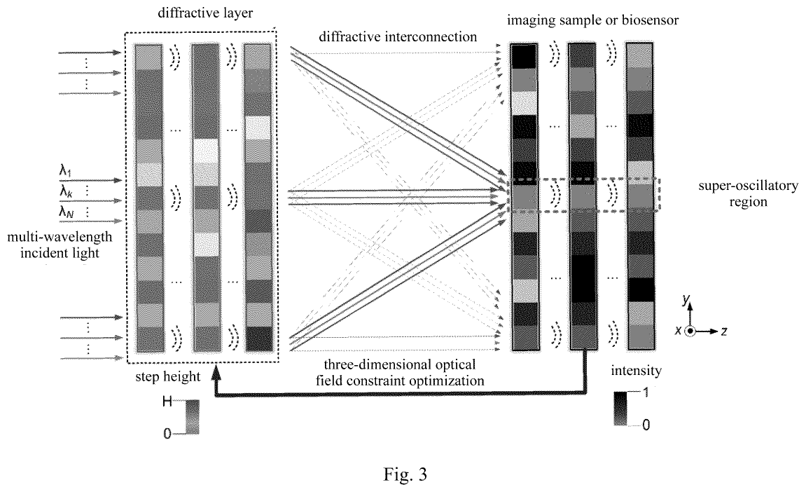

Referring to FIG. 3, a forward propagation model of the SODNN is established based on the angular spectrum theory. A complex amplitude U_{λ}_{ₖ} of an optical field for multi-wavelength incident light with a wavelength of λₖ (k=1, 2, . . . , N) is modulated layer-by-layer by at least one layer of diffractive structure of the SODNN, wherein N is a positive integer. Assuming a complex-valued modulation function of the multiple diffractive layers of the SODNN is M_{λ}_{ₖ} (ΔH, zᵢ), this represents that the SODNN modulates the incident optical field onto the detection plane that is at a distance zᵢ from the SODNN to acquire the output optical field, wherein ΔH represents the step height of each diffractive unit in the SODNN. The phase distribution ϕ_{λ}_{ₖ} of the incident optical field is modulated by optimizing the step height to generate an optical path difference. Specifically, the relationship between the step height ΔH and the phase distribution ϕ_{λ}_{ₖ} is:

$$Δ H = {λ}_{k} {ϕ}_{{λ}_{k}} / 2 πΔ {n}_{{λ}_{k}} ,$$

where Δn_{λ}_{ₖ} represents a refractive index of a material that varies with the wavelength λₖ.

Therefore, after the incident optical field with the wavelength λₖ on the output plane that is at a distance zᵢ from the SODNN undergoes the complex-valued modulation by the SODNN, its output optical field U′_{λ}_{ₖ}(zᵢ) may be expressed as:

$${U}_{{λ}_{k}}^{′} ( {z}_{i} ) = {M}_{{λ}_{k}} ( Δ H , {z}_{i} ) {U}_{{λ}_{k}} ,$$

and if the output optical field is measured by a detector and photoelectric nonlinear transformation is performed on the output optical field, the light intensity I_{λ}_{ₖ}(zᵢ) of the output optical field is acquired as:

$${I}_{{λ}_{k}} ( {z}_{i} ) = {\vert {U}_{{λ}_{k}}^{′} ( {z}_{i} ) \vert}^{2} = {\vert {M}_{{λ}_{k}} ( Δ H , {z}_{i} ) {U}_{{λ}_{k}} \vert}^{2} .$$

Since the step height of each diffractive unit is fixed under different wavelength channels, the SODNN model may effectively eliminate chromatic aberration caused by wavelength-dependent phase delay. For multi-wavelength incidence, total intensity I(zᵢ) of different wavelengths on the output plane of the SODNN may be expressed as superposition of intensity distributions I_{λ}_{ₖ}(zᵢ) detected at each wavelength Ak, which may be expressed specifically by the following formula:

$$I ( {z}_{i} ) = {\sum }_{{λ}_{k}} {I}_{{λ}_{k}} ( {z}_{i} ) .$$

The SODNN uses the three-dimensional (3D) optical field constraint conditions to optimize the diffractive units and to optimize the morphology of the super-oscillatory focal spot within a desired three-dimensional optical field spatial range zᵢ E [f−Δf, f+Δf], wherein [f−Δf, f+Δf] represents a range within a distance Δf before and after the focal length f.

At the three-dimensional spatial coordinates (xᵢ, yᵢ, zᵢ), an ideal super-oscillatory focal spot should have an extremely high focal spot intensity (xᵢ, yᵢ, zᵢ)→∞ and extremely low side lobe intensity I_{Σ}_{ⱼ}₍ₓ_{ⱼ}_{,y}_{ⱼ}_{,z}_{ⱼ}₎→0, wherein the three-dimensional spatial coordinates (xᵢ, yᵢ, zᵢ) indicate a distribution position of the super-oscillatory focal spot, and the set Σⱼ(xᵢ, yᵢ, zᵢ) of the three-dimensional spatial coordinates indicates distribution positions of the side lobes. On this basis, by taking the ideal output optical field as the target of optimization, the SODNN executes the function of a neuromorphic photonic processor based on the first constraint condition of the three-dimensional optical field constraint conditions, and utilizes weighted optical diffractive interconnection of large-scale diffractive units to implement the required optical super-oscillation function, to minimize the difference of the light intensity distribution of the super-oscillatory focal spot and the light intensity distribution of the side lobes from the light intensity distribution of the ideal output optical field.

Additionally or alternatively, in order to further improve the effect of super-resolution microscopic imaging, the three-dimensional optical field constraint conditions may further include a second constraint condition, which is an energy constraint condition configured to minimize the light intensity outside the super-oscillatory region. Thus, the energy transfer efficiency of the super-oscillatory region may be maximized.

By way of example, by taking the three-dimensional optical field constraint conditions including the first constraint condition and the second constraint condition as an example, the expression of the three-dimensional optical field constraint conditions includes:

$${min}_{Δ H} ( {\sum }_{{z}_{i} ∈ [ f - Δ f , f + Δ f ]} \{ {( ( {I}_{( {x}_{i} , {y}_{i} , {z}_{i} )} + {I}_{{\sum }_{j} ( {x}_{j} , {y}_{j} , {z}_{\text{?}} )} ) - {I}_{target} )}^{2} + MSE ( {I}_{( x , y , z ) ∉ ( {x}_{i} , {y}_{i} , {z}_{\text{?}} )} ) \} ) ,$$

$$\text{?} \text{indicates text missing or illegible when filed}$$

where min( ) represents a minimization function, ΔH represents a step height distribution of the diffractive units, [f−Δf, f+Δf] represents the three-dimensional optical field spatial range, f represents a focal length, zᵢ represents a distance between the diffractive layer and an output plane, I(xᵢ,yᵢ,zᵢ) represents a light intensity distribution of a super-oscillatory focal spot at three-dimensional spatial coordinates (xᵢ, yᵢ, zᵢ), I_{Σ}_{ⱼ}₍ₓ_{ⱼ}_{,y}_{ⱼ}_{,z}_{ⱼ}₎ represents a light intensity distribution of side lobes at a set Σⱼ(xᵢ, yᵢ, zᵢ) of the three-dimensional spatial coordinates, I_{target} represents an ideal light intensity distribution of the super-oscillatory focal spot, and MSE( ) represents a mean square error function, so as to maximize the energy transfer efficiency of the super-oscillatory region by minimizing the light intensity outside the super-oscillatory region.

In an example, a super-oscillatory diffractive neural network is trained based on the three-dimensional optical field constraint conditions to optimize the step heights of the diffractive units in the super-oscillatory diffractive neural network to acquire a trained super-oscillatory diffractive neural network, which comprises the following steps:
Step 1: constructing a network structure of an initial super-oscillatory diffractive neural network, the network structure including initialization parameters of the diffractive units in each diffractive layer, and the initialization parameters including initialized step heights;
Step 2: simulating a process of incident light passing through the network structure to acquire an output optical field;
by way of example, the incident light may be either single-wavelength incident light or multi-wavelength incident light; the specific type of the incident light may be determined based on the application scenarios of the super-oscillatory diffractive neural network; for example, when the super-oscillatory diffractive neural network acquired by training is applied to a multi-wavelength scenario, the incident light during the training process is consistent with the multi-wavelength incident light in this multi-wavelength scenario;
Step 3: using a detector to detect the light intensity distribution of the super-oscillatory focal spot at the three-dimensional spatial coordinates (xᵢ, yᵢ, zᵢ), the light intensity distribution of the side lobes at the set Σⱼ(xᵢ, yᵢ, zᵢ) of the three-dimensional spatial coordinates, and the light intensity distribution outside the super-oscillatory region in the output optical field,
wherein the detector is a simulated detector operating on an electronic apparatus, and the characteristics of the detector (such as sensitivity, response function, and/or noise level) are preset in the electronic apparatus; and
Step 4: determining whether the current output optical field meets the three-dimensional optical field constraint conditions based on the respective light intensity distributions, wherein if the three-dimensional optical field constraint conditions are not met, parameters of the diffractive units are optimized using a deep learning algorithm, and the Steps 2 and 3 are executed again until the output optical field meets the three-dimensional optical field constraint conditions, and the trained super-oscillatory diffractive neural network is acquired.

Optionally, the deep learning algorithm includes, but is not limited to, the stochastic gradient descent algorithm or the gradient descent algorithm. This embodiment does not limit the implementation mode of the deep learning algorithm.

Step 203: modulating the incident light based on the trained super-oscillatory diffraction neural network to generate a super-oscillatory effect in the three-dimensional space and acquire a super-resolution microscopic imaging result.

The incident light is a simulated light source generated by an electronic apparatus simulating the application scenario of the super-oscillatory diffractive neural network. In this case, a mathematical model of the super-oscillatory diffractive neural network modulates the simulated incident light, and then the output optical field is detected by a simulated detector to acquire a super-resolution microscopic imaging result of the mathematical model. Optionally, the super-resolution microscopic imaging result may be used to generate numerical analysis results described below, in order to analyze network performance of the super-oscillatory diffractive neural network.

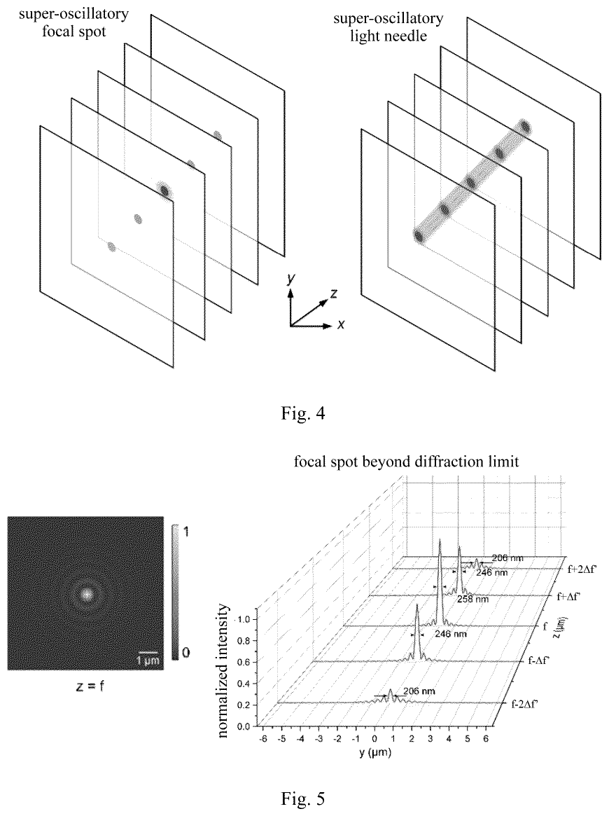

In this embodiment, the SODNN modulates the incident optical field to generate a super-oscillation effect in the three-dimensional space, which may achieve a super-resolution focal spot or a super-oscillatory light needle (i.e., a super-resolution microscopic imaging result), as shown in FIG. 4.

In summary, according to the method for achieving super-resolution microscopic imaging by a super-oscillatory diffractive neural network provided in this embodiment, a trained super-oscillatory diffractive neural network is acquired by training a super-oscillatory diffractive neural network by acquiring the three-dimensional optical field constraint conditions to optimize the step heights of the diffractive units in the super-oscillatory diffractive neural network. The incident light is modulated based on the trained super-oscillatory diffractive neural network to generate a super-oscillation effect in the three-dimensional space, thereby acquiring a super-resolution microscopic imaging result. The method may achieve the effect of generating a super-oscillatory focal spot with a large field of view with zero side lobes, a long working distance, a long depth of field, and achromatism in any local area, and may solve the technical problems of small fields of view resulting from strong side lobes, short working distances, limited depth-of-focus, and chromatic aberration caused by wavelength-dependent phase delay existing in the conventional optical super-oscillation phenomenon generation methods, thereby improving the effect of super-resolution microscopic imaging.

Next, the SODNN acquired by training under different three-dimensional optical field constraint conditions in the above embodiment will be described by way of examples. In this embodiment, the description is made by taking the following case as an example: the Δf in the three-dimensional optical field constraint conditions for training the SODNN is 0, that is, the three-dimensional optical field spatial range is f; f=250 μm; the SODNN comprises one diffractive layer; the size of each diffractive unit is set to 2/2×2/2; and the number of diffractive units in the diffractive layer is 2500×2500. If λ represents a wavelength of incident coherent light and λ=632.8 nm, a corresponding physical size of the diffractive layer is 0.79 mm×0.79 mm.

After the incident light is modulated by the above SODNN, a super-oscillatory focal spot shown in the left part of FIG. 5 may be acquired. A FWHM of the super-oscillatory focal spot is shown in the right part of FIG. 5. As shown in FIG. 5, the SODNN forms a super-oscillatory focal spot with almost no side lobes (or substantially zero side lobes) at a long focal length f=250 μm (˜400λ), and the FWHM at the focal length f is 258 nm (˜0.407λ).

In this embodiment, by optimizing the diffractive units in the SODNN at the focal length f (i.e., when Δf in the above three-dimensional optical field constraint conditions is 0), a super-oscillatory focal spot with a large field of view and zero side lobes may be acquired.

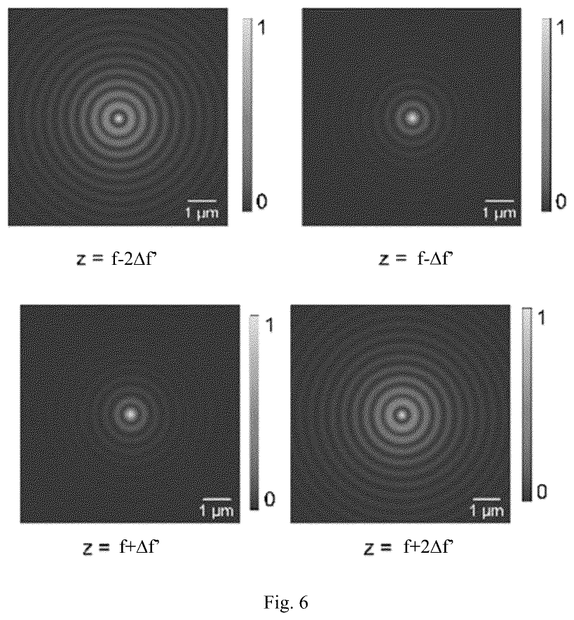

In the embodiment illustrated by FIG. 5, once deviating from the three-dimensional optical field spatial range f, side lobes will appear immediately, accompanied by a decrease in the FWHM and a reduction in the intensity of the super-oscillatory focal spot. For example, as shown in FIG. 6, side lobes appear at four different out-of-focus planes f−2Δf′, f-Δf, f+Δf, and f+2Δf (Δf′=0.25 μm). Moreover, as shown in the right part of FIG. 5, the FWHM decreases to 206 nm (˜0.325λ), 246 nm (˜0.388λ), 246 nm (˜0.388λ), and 206 nm (˜0.325λ), respectively. For the out-of-focus planes, as the size of the central spot decreases, the intensity of the side lobes increases exponentially relative to the central spot.

Based on the above phenomenon, in some embodiments, in order to acquire a long depth of field, i.e., to maintain the morphology of the super-oscillatory focal spot unchanged within a certain three-dimensional spatial range to form a super-oscillatory light needle, the Δf in the three-dimensional optical field constraint conditions may be set to not equal to 0.

In this embodiment, the description is made by taking the following case as an example: the Δf in the three-dimensional optical field constraint conditions for training the SODNN is 6Δf, that is, the three-dimensional optical field spatial range is [f−6Δf, f+6Δf], wherein f=100 μm and Δf=0.5 μm; the SODNN comprises one diffractive layer; the size of each diffractive unit is set to λ/2×λ/2; and the number of diffractive units in the diffractive layer is 1500×1500. If λ represents a wavelength of incident coherent light and λ=632.8 nm, a corresponding physical size of the diffractive layer is 0.47 mm×0.47 mm.

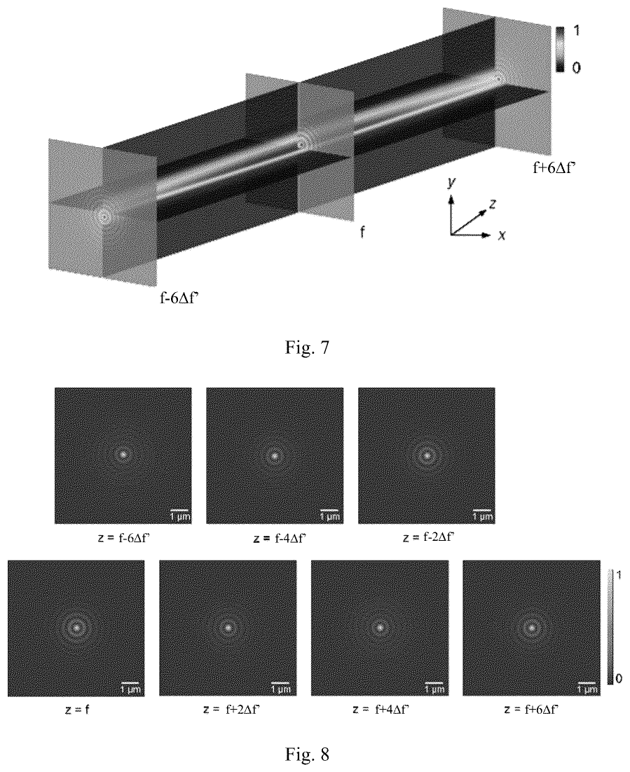

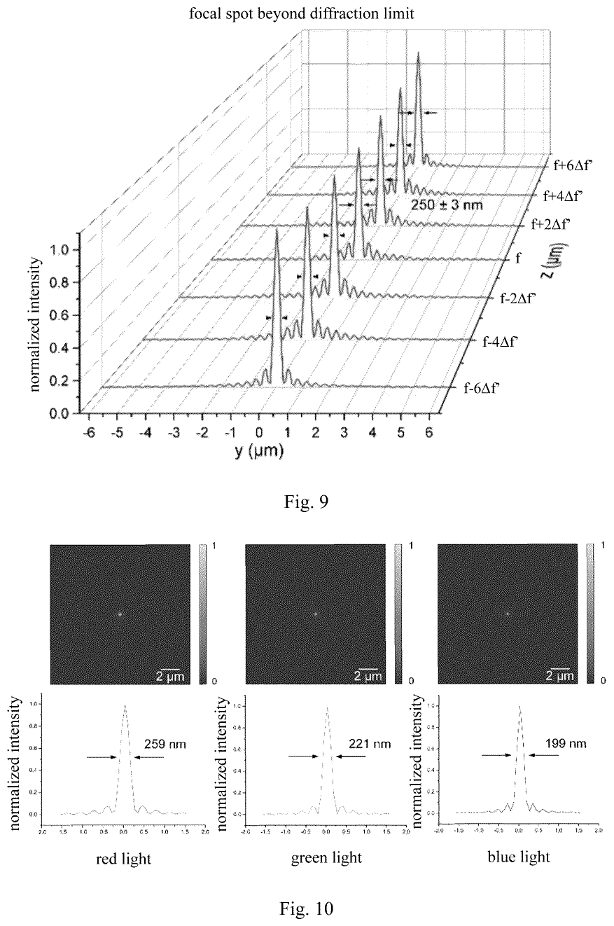

After the incident light is modulated by the above SODNN, a super-oscillatory focal light needle as shown in FIG. 7 may be acquired. With a sampling interval of 2Δf′, seven positions are selected within a range of [f−6Δf, f+6Δf] to further test the morphology of the super-oscillatory light needle. As a result, slices of the super-oscillatory light needle shown in FIG. 8 and the FWHM corresponding to each slice of the super-oscillatory light needle shown in FIG. 9 are acquired. As shown in FIG. 7, within the three-dimensional optical field spatial range [f−6Δf, f+6Δf], a super-oscillatory light needle with a longitudinal degree of freedom of 6 μm (˜10λ) is formed. Moreover, as shown in FIG. 8 and FIG. 9, the super-oscillatory light needle maintains uniform light intensity and a consistent FWHM (i.e., 250 nm±3 nm).

In one example, the following case is taken as an example for description: the incident light used when training the SODNN is multi-wavelength incident light, specifically including blue light with a wavelength of 473 nm (λ₁), green light with a wavelength of 532 nm (λ₂), and red light with a wavelength of 632.8 nm (λ₃); the SODNN comprises one diffractive layer; the size of each diffractive unit is set to (λ₃)/2×(λ₃)/2; and the number of diffractive units in the diffractive layer is 2500×2500. A corresponding physical size of the diffractive layer is 0.79 mm×0.79 mm.

After the incident light is modulated by the above SODNN, super-oscillatory focal spots corresponding to the different wavelengths of the incident light, as shown in the upper part of FIG. 10, may be acquired. The FWHM corresponding to each super-oscillatory focal spot is shown in the lower part of FIG. 10. As shown in FIG. 10, for the incident light of different wavelengths, the SODNN may consistently form multi-wavelength super-oscillatory focal spots with almost no side lobes at a long focal length of f=250 μm (˜400λ₃), which may eliminate the chromatic aberration caused by the phase delay associated with multiple wavelengths. The red light, green light, and blue light produce FWHMs of 259 nm, 221 nm, and 199 nm, respectively. At this time, a diffraction limit of the system is 0.61λ/NA=456 nm, and each FWHM is smaller than the diffraction limit. That is, the SODNN exceeds the diffraction limit. Here, NA represents a numerical aperture, which describes the ability of an optical system to collect light.

In summary, the SODNN provided in this embodiment is able to modulate incident light of different wavelengths into super-oscillatory focal spots at the same three-dimensional spatial position, thus solving the chromatic aberration problem caused by the phase delay associated with multiple wavelengths.

In one example, the following case is taken as an example for description: the incident light used when training the SODNN is multi-wavelength incident light, specifically including blue light with a wavelength of 473 nm (λ₁), green light with a wavelength of 532 nm (λ₂), and red light with a wavelength of 632.8 nm (λ₃); a plurality of super-oscillatory regions are provided, and are arranged in a 3×5 matrix; the SODNN comprises one diffractive layer; the size of each diffractive unit is set to (λ₃)/2×(λ₃)/2; and the number of diffractive units in the diffractive layer is 2500×2500. A corresponding physical size of the diffractive layer is 0.79 mm×0.79 mm.

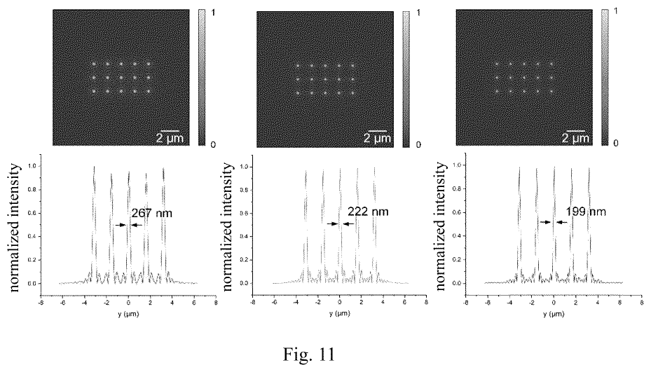

After the multi-wavelength incident light is modulated by the SODNN, multi-focus (i.e., 3×5) super-oscillatory focal spot arrays as shown in the upper part of FIG. 11 may be acquired. The FWHM corresponding to each column of super-oscillatory focal spots is shown in the lower part of FIG. 11. As shown in FIG. 11, the multi-wavelength and multi-focus SODNN may achieve a 3×5 super-oscillatory focal spot array in red, green, and blue light channels. The FWHMs corresponding to the incident light of different wavelengths are 267 nm, 222 nm, and 199 nm, respectively. At this time, a diffraction limit of the system is 456 nm, and each FWHM is smaller than the diffraction limit. That is, the SODNN exceeds the diffraction limit.

In summary, the SODNN provided in this embodiment is able to modulate incident light of different wavelengths to multiple super-oscillatory regions to form multi-focus super-oscillatory focal spots, thus expanding the application scenarios of the SODNN.

In one example, the following case is taken as an example for description: the incident light used when training the SODNN is red light with a wavelength of 632.8 nm; a plurality of super-oscillatory regions are provided, and form a preset pattern; the SODNN comprises one diffractive layer; the size of each diffractive unit is set to (λ₃)/2×(λ₃)/2; and the number of diffractive units in the diffractive layer is 2500×2500. A corresponding physical size of the diffractive layer is 0.79 mm×0.79 mm.

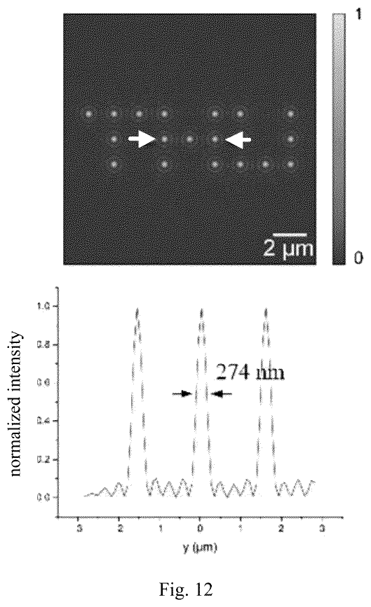

If the preset pattern is a “THU” pattern, after the multi-wavelength incident light is modulated by the above SODNN, a multi-focus super-oscillatory focal spot array as shown in the upper part of FIG. 12 may be acquired. The FWHMs corresponding to three different super-oscillatory focal spots in the upper part of FIG. 12 are shown in the lower part of FIG. 12. As shown in FIG. 12, the SODNN forms a “THU” pattern with the super-oscillatory focal spots at different three-dimensional spatial positions, and the FWHM of the super-oscillatory focal spots is 274 nm.

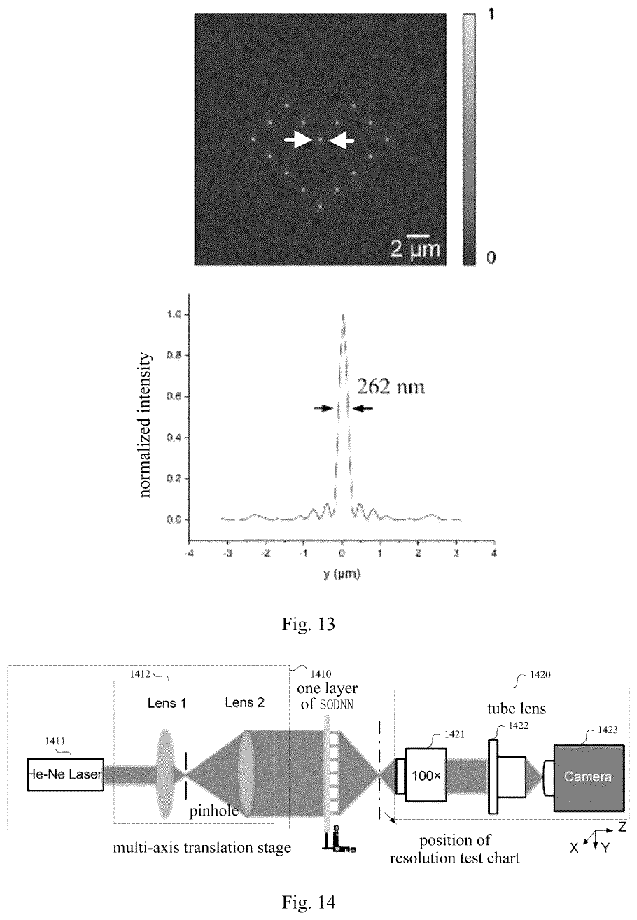

If the preset pattern is a heart-shaped pattern, after the multi-wavelength incident light is modulated by the above SODNN, a multi-focus super-oscillatory focal spot array as shown in the upper part of FIG. 13 may be acquired. The FWHM corresponding to one super-oscillatory focal spot in the upper part of FIG. 13 is shown in the lower part of FIG. 13. As shown in FIG. 13, the SODNN forms a heart-shaped pattern with the super-oscillatory focal spots at different three-dimensional spatial positions, and the FWHM of the super-oscillatory focal spots is 262 nm.

As shown in FIGS. 12 and 13, the FWHMs of the super-oscillatory focal spots formed by the SODNN are all smaller than the diffraction limit of 456 nm. That is, the SODNN exceeds the diffraction limit. Moreover, the SODNN acquired by training is able to form complex preset patterns with multi-focus super-oscillatory focal spots, and has a high degree of flexibility and universality.

For ease of understanding, the SODNNs described in the above method embodiments all refer to the mathematical models of the SODNNs. In the following device embodiments, the SODNNs refer to physical optical elements of the SODNNs fabricated based on the mathematical models.

Optionally, based on the above embodiments, the present disclosure further provides a device for achieving super-resolution microscopic imaging by a super-oscillatory diffractive neural network. The device comprises a super-oscillatory diffractive neural network configured to modulate incident light to generate a super-oscillation effect in a three-dimensional space, wherein the super-oscillatory diffractive neural network comprises at least one diffractive layer, each of which comprises a plurality of diffractive units; step heights of the diffractive units are acquired from training based on preset three-dimensional optical field constraint conditions, the three-dimensional optical field constraint conditions including a first constraint condition and/or a second constraint condition, the first constraint condition being configured to indicate that within a desired three-dimensional optical field spatial range, a difference of a light intensity distribution of a super-oscillatory focal spot and a light intensity distribution of side lobes from a light intensity distribution of an ideal output optical field is minimized, and the second constraint condition being configured to indicate that within the desired three-dimensional optical field spatial range, light intensity outside a super-oscillatory region is minimized.

After being trained using one of the methods provided in the above embodiments, a super-oscillatory diffractive neural network is fabricated based on network parameters acquired from the training. Since a super-oscillatory diffractive neural network acquired by employing one of the methods provided in the above embodiments may modulate incident light to acquire a super-oscillatory focal spot with zero side lobes and a large field of view, a super-oscillatory diffractive neural network thus fabricated may also acquire a super-oscillatory focal spot with zero side lobes and a large field of view.

Optionally, the super-oscillatory diffractive neural network may be fabricated by employing two-photon 3D printing technology, or by employing other fabrication methods such as electron beam lithography. This embodiment does not limit the production method of the super-oscillatory diffractive neural network.

Optionally, the device for achieving super-resolution microscopic imaging by a super-oscillatory diffractive neural network further comprises a light source and an imaging assembly located on both sides of the super-oscillatory diffractive neural network, respectively. As shown in FIG. 14, the light source 1410 is located at an input end of the super-oscillatory diffractive neural network and is configured to generate incident light.

By way of example, the light source 1410 comprises a laser 1411 and a spatial filter 1412.

The laser 1411 is configured to generate laser light with a preset wavelength. Optionally, the laser 1411 may be a helium-neon laser with a power of 5 mW, and the preset wavelength may be 632.8 nm. In other embodiments, the laser 1411 may also be of other types, and the preset wavelength may also take other values. This embodiment does not limit the type of the laser 1411.

The spatial filter 1412 is configured to collimate laser light generated by the laser 1411, so as to transmit collimated incident light to the input end of the super-oscillatory diffractive neural network. Optionally, along a direction of light propagation, the spatial filter 1412 comprises a convex lens (Lens 1), a pinhole, and a concave lens 2 (Lens 2). In other embodiments, the spatial filter 1412 may further comprise other components. This embodiment does not limit the implementation mode of the spatial filter 1412.

The imaging assembly 1420 is disposed at an output end of the super-oscillatory diffractive neural network and is configured to perform photoelectric nonlinear transformation on an output optical field to acquire a super-resolution microscopic imaging result. An object to be imaged is placed between the output end of the super-oscillatory diffractive neural network and the imaging assembly 1420, specifically within a three-dimensional optical field spatial range defined by the three-dimensional optical field constraint conditions corresponding to the super-oscillatory diffractive neural network.

By way of example, the imaging assembly 1420 which comprises an Olympus objective lens 1421 (with a magnification of 100× and NA=0.9), a tube lens 1422 with a focal length of f=180 mm, and a CMOS camera 1423 is taken as an example for description. The Olympus objective lens is configured to image the super-oscillatory focal spot, and the tube lens is arranged between the Olympus objective lens and the CMOS camera to assist the Olympus objective lens in imaging on the CMOS camera. In other embodiments, the imaging assembly 1420 may also be other components. This embodiment does not limit the type of the imaging assembly 1420.

Assuming that the fabricated super-oscillatory diffractive neural networks comprise two types, both of which have one diffractive layer, have a size of 500 nm×500 nm for each diffractive unit in the diffractive layer, have a step height of 0 nm or 500 nm for each diffractive unit, and have 200×200 diffractive units. The difference between the two types of super-oscillatory diffractive neural networks lies in that one of the super-oscillatory diffractive neural networks is configured to perform modulation to acquire a single-focus super-oscillatory focal spot, while the other is configured to perform modulation to acquire 2×2 multi-focus super-oscillatory focal spots. FIG. 15 is a schematic diagram of a single-focus SODNN (shown in the leftmost part of FIG. 15) and a 2×2 multi-focus SODNN (shown in the middle part of FIG. 15). An enlarged part of the 2×2 multi-focus SODNN characterized by an electron microscope (EM) is shown in the rightmost part of FIG. 15.

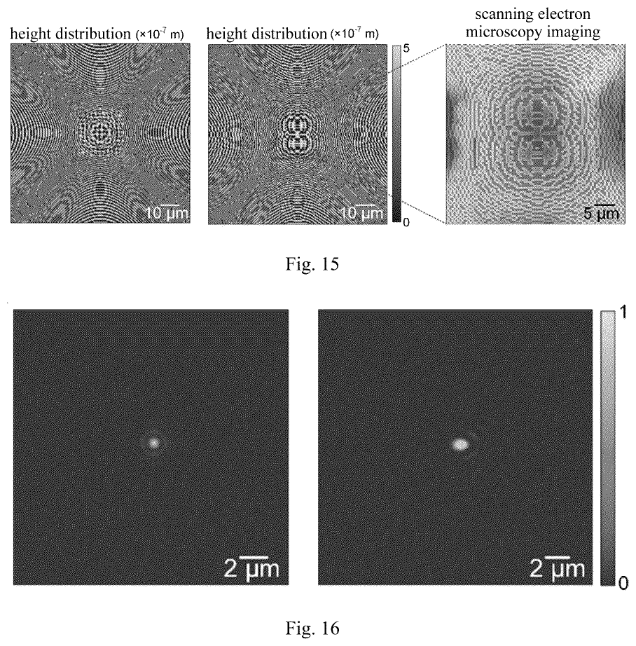

The SODNN shown in FIG. 15 is used to modulate incident light with a wavelength of λ=632.8 nm. If the focal length f is 20 μm, a numerical analysis result of the acquired single-focus super-oscillatory focal spot is shown in the left part of FIG. 16, while an experimental measurement result of the acquired single-focus super-oscillatory focal spot is shown in the right part of FIG. 16. As shown in FIG. 16, the numerical analysis result of the single-focus super-oscillatory focal spot is highly consistent with the experimental measurement result.

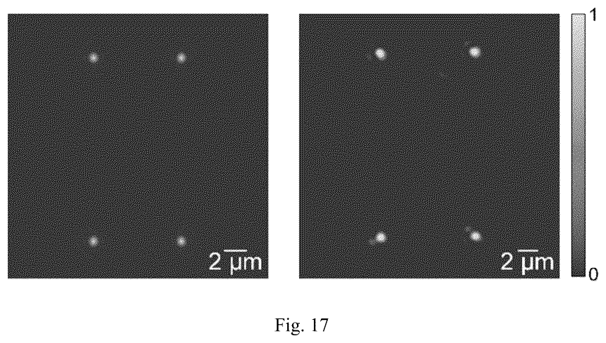

The SODNN shown in FIG. 15 is used to modulate incident light with a wavelength of λ=632.8 nm. If the focal length f is 20 μm, a numerical analysis result of the acquired 2×2 super-oscillatory focal spot array is shown in the left part of FIG. 17, while an experimental measurement result of the acquired 2×2 super-oscillatory focal spot array is shown in the right part of FIG. 17. As shown in FIG. 17, the numerical analysis result of the 2×2 super-oscillatory focal spot array is highly consistent with the experimental measurement result.

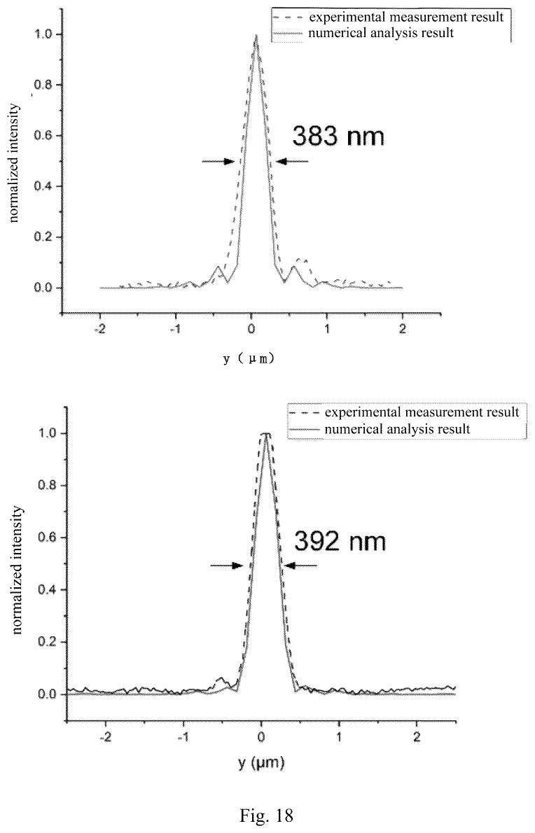

In addition, the FWHMs acquired from the numerical analysis result and the experimental measurement result of the single-focus super-oscillatory focal spot are shown in the upper part of FIG. 18, which are 307 nm and 383 nm, respectively. The FWHMs acquired from the numerical analysis result and the experimental measurement result of the 2×2 multi-focus super-oscillatory focal spot array are shown in the lower part of FIG. 18, which are 340 nm and 392 nm, respectively. Although there is a certain discrepancy between the experimental measurement results and the numerical analysis results due to systematic errors in the optical processing, the experimental measurement results still exceed the diffraction limit (0.61λ/NA=415 nm).

The numerical analysis result refers to network performance data of the super-oscillatory diffractive neural network acquired through analysis (or simulation) by an electronic apparatus. The experimental measurement result refers to network performance data of the super-oscillatory diffractive neural network measured by a real optical system. The network performance data include, but are not limited to, the imaging result, the intensity distribution, and/or the FWHM distribution of the super-oscillatory focal spot.

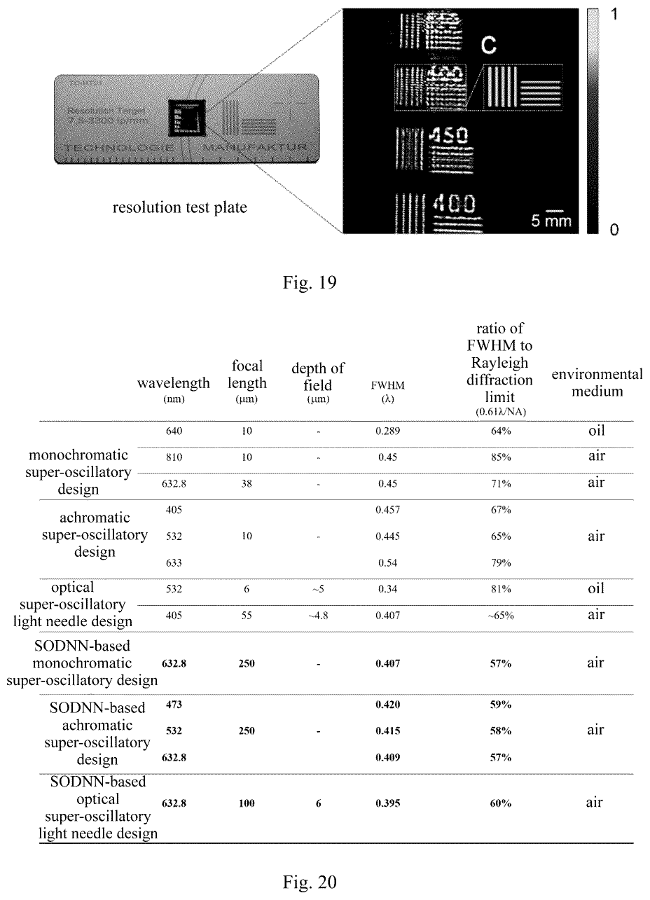

Optionally, in the device for super-resolution microscopic imaging shown in FIG. 14, the resolution of the SODNN is tested by placing a resolution test plate at the position of a resolution test chart as an object under test. Here, the resolution test plate typically contains a series of lines or patterns of known sizes, which are arranged at certain intervals to facilitate the measurement of the resolution of the optical system. By way of example, the pattern structure of the resolution test plate is realized by processing metal chromium (Cr) on a glass substrate (SiO₂). If a signal for image reconstruction during imaging is acquired from a central part of the CMOS camera, when the resolution test plate is imaged through the Olympus objective lens, an imaging result acquired is shown in the left part of FIG. 19, and when the resolution test plate is imaged through the SODNN, an imaging result acquired is shown in the right part of FIG. 19. As shown in FIG. 19, the Olympus objective lens fails to clearly image the 500-line-pair pattern on the resolution test plate, while the SODNN is able to clearly image the 500-line-pair pattern, indicating that the SODNN has an imaging performance comparable to that of a microscope imaging system.

In summary, after fabricating the SODNN acquired by training, the device for super-resolution microscopic imaging thus acquired may still achieve a super-oscillatory focal spot with zero side lobes and a large field of view, maintaining substantially the same optical performance as the SODNN acquired through training in the electronic apparatus.

To further illustrate the performance of the device for achieving super-resolution microscopic imaging using the super-oscillatory diffractive neural network provided by the present disclosure, this embodiment will introduce results of a comparison between the device and the conventional super-oscillatory lenses. FIG. 20 shows a comparative analysis of the technical solutions of the SODNN and several existing typical super-oscillatory lenses. As shown in FIG. 20, the SODNN may achieve a long working distance of several hundred micrometers, while other technical solutions may only achieve a very short working distance of about tens of micrometers (the longest being 55 μm). In terms of the working distance, the SODNN has achieved an improvement by an order of magnitude. The SODNN may also achieve a depth of field greater than 6 μm, with a ratio of FWHM to the Rayleigh diffraction limit being less than 60%. The above results all demonstrate that the SODNN outperforms conventional super-oscillatory lenses in terms of super-oscillatory diffraction performance.

To determine the number of diffractive layers, the number of diffractive units, and the size of the diffractive units in the super-oscillatory diffractive neural network, the following will provide examples illustrating the network performance of the super-oscillatory diffractive neural network under different numbers of diffractive layers, different numbers of diffractive units, and different sizes of diffractive units, respectively.

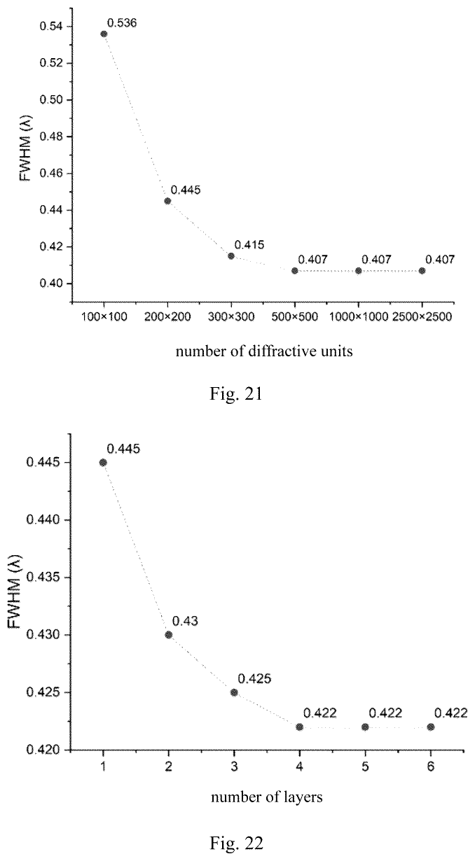

Referring to FIG. 21 which is a schematic diagram of network performance variation with different numbers of diffractive units in one diffractive layer, the size of the diffractive units is fixed at λ/2×λ/2. In FIG. 21, the number of diffractive units is denoted as K×K, K being 100, 200, 300, 500, 1000, and 2500, respectively. As shown in FIG. 21, as the number of diffractive units increases, the FWHM of the super-oscillatory focal spot gradually decreases.

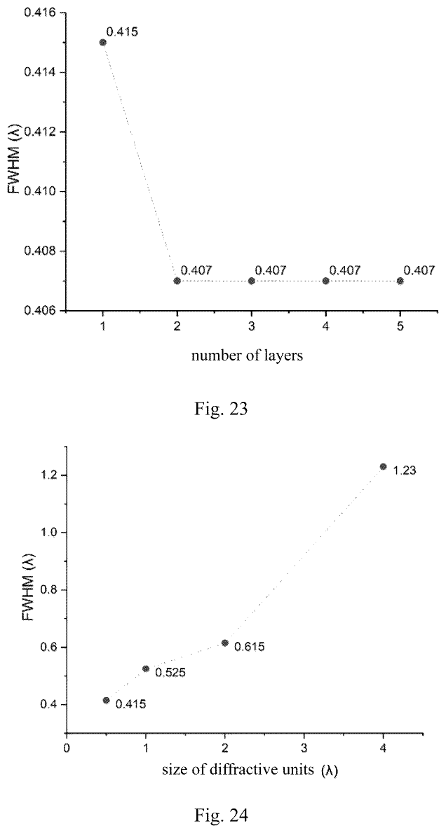

FIG. 22 is a schematic diagram of network performance variation with different diffractive layers when the number of diffractive units is fixed at 200×200 and the size of the diffractive units is fixed at λ/2×λ/2, and FIG. 23 is a schematic diagram of network performance variation with different diffractive layers when the number of diffractive units is fixed at 300×300 and the size of the diffractive units is fixed at λ/2×λ/2. As shown in FIGS. 22 and 23, as the number of diffractive layers increases, the FWHM of the super-oscillatory focal spot gradually decreases.

FIG. 24 is a schematic diagram of network performance variation when the number of diffractive units is fixed at 300×300, the number of diffractive layers is fixed at one, and the sizes of the diffractive units are set to λ/2×λ/2, λ×λ, 2λ×2λ, and 4λ×4λ, respectively. As shown in FIG. 24, as the size of the diffractive units increases, the FWHM of the super-oscillatory focal spot gradually increases, and the network performance deteriorates.

As can be seen from the above examples, as the number of diffractive layers increases and the number of diffractive units in each diffractive layer increases, the FWHM of the super-oscillatory spot with zero side lobes and a large field of view will gradually decrease and stabilize at ˜0.4072 (as shown in FIGS. 21 and 23). By comparing FIG. 23 and FIG. 24, it may be observed that when the number of diffractive units is small, the FWHM of the side-lobe-free super-oscillatory spot cannot stabilize at ˜0.4072, regardless of the increase in the number of diffractive layers. This indicates that adjusting the number of diffractive units has a greater impact on the FWHM than adjusting the number of diffractive layers. As shown in FIG. 24, as the size of the diffractive units increases, the FWHM of the side-lobe-free super-oscillatory spot gradually increases.

Based on the above comparison results, in one possible implementation, the number of diffractive layers in the SODNN may be set to one. In this case, a single-layer SODNN with a sufficient number of diffractive units may achieve the same network performance as a multi-layer SODNN, thereby significantly reducing hardware complexity, system errors, and experimental complexity.

By way of example, a sufficient number of diffractive units refers to 500×500 diffractive units or more. In practical implementation, depending on different imaging requirements, the number of diffractive units in a single diffractive layer may also be less than 500×500. For example, for imaging applications where network performance requirements are not stringent, a smaller number of diffractive units may be set.

Optionally, the number of diffractive units may also be determined based on the signal-to-noise ratio and/or the spot brightness of the super-oscillatory focal spot, wherein, the number of diffractive units is positively correlated with the signal-to-noise ratio and the spot brightness. For example, for imaging applications with high signal-to-noise ratio requirements, a larger number of diffractive units, such as 2500×2500, may be set, and for imaging applications with low signal-to-noise ratio requirements, a smaller number of diffractive units, such as 500×500, may be set.

Optionally, the size of the diffractive units may be set to half the wavelength of the incident light, that is, the size of the diffractive units is λ/2×λ/2, with λ representing the wavelength of the incident light. For multi-wavelength incident light, λ is any one of the multiple wavelengths.

There are two theories for describing the light wave diffraction phenomenon of the diffractive unit, namely, the scalar diffraction theory and the vector diffraction theory. The computational complexity of the scalar diffraction theory is lower than that of the vector diffraction theory. A diffractive unit size of λ/2×λ/2 serves as a demarcation line between the applicability of the scalar diffraction theory and the applicability of the vector diffraction theory. That is, if the size of the diffractive unit is smaller than λ/2×λ/2, the scalar diffraction theory may no longer be suitable for describing the diffraction phenomena of the diffractive unit. On this basis, in this embodiment, by setting the size of the diffractive unit to λ/2×λ/2, the light wave diffraction phenomenon of the diffractive unit may be described using the scalar diffraction theory. This reduces the computational complexity in designing the SODNN, and also minimizes the size of the diffractive unit as much as possible to reduce the FWHM of the super-oscillatory focal spot, thereby ensuring the network performance.

As is clear from the above embodiments, the SODNN provided by the present disclosure may modulate an incident optical field to generate an optical super-oscillation effect in any 3D space and generate a super-resolution focal spot. On this basis, in one example, by training a series of SODNNs and loading them into a reconfigurable apparatus such as a spatial light modulator (SLM), dynamic scanning of a super-oscillatory point may be achieved. In this case, the device for super-resolution microscopic imaging comprises a reconfigurable apparatus comprising multiple super-oscillatory diffractive neural networks. The three-dimensional spatial coordinates of the super-oscillatory focal spots formed by different super-oscillatory diffractive neural networks are different.

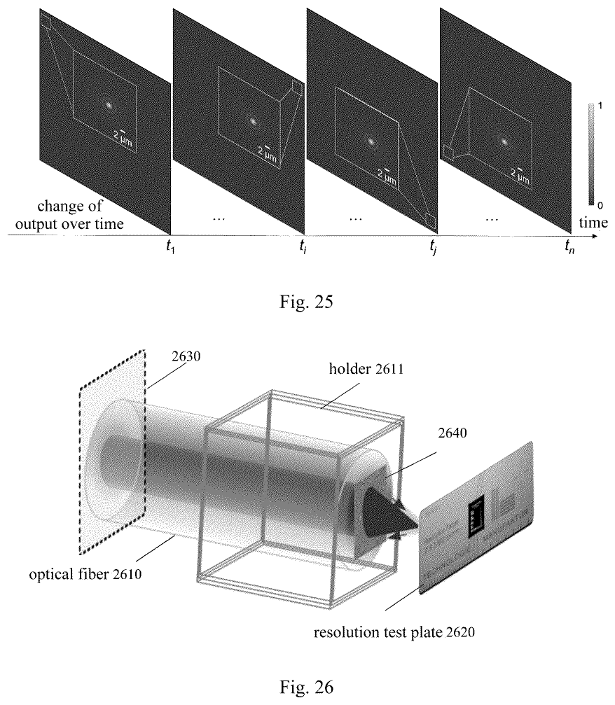

For example, in a series of SODNNs acquired by training, the number of modulation units is uniformly set to 2500×2500, the size of the diffractive units is λ/2×λ/2, with λ=632.8 nm, the corresponding physical size of a modulation layer is 0.79 mm×0.79 mm, a focal length is f=250 μm, and the FWHM is maintained at 258 nm (˜0.407λ) and does not vary with the change in the position of the super-oscillatory focal spot. A series of SODNNs with different modulation coefficients are used to reconstruct the incident optical field. As a result, raster scanning of the acquired super-oscillatory spot at any position on the entire detection plane is achieved for imaging. The acquired results are shown in FIG. 25. As shown in FIG. 25, the SODNN may focus the super-oscillatory spot at four outermost boundary positions on the detection plane, indicating that the SODNN may achieve scanning at any position on the detection plane. Assuming that the SODNN operates on a high-speed SLM at 1000 fps and uses the FWHM as the scanning interval, the SODNN may achieve a scanning range of 66.56 square micrometers per second.

In one example, the device for super-resolution microscopic imaging may also be implemented in a more compact way. In this embodiment, a more compact solution in which an endoscope is formed by integrating an SODNN with an optical fiber is taken as an example for description. Here, the device for super-resolution microscopic imaging comprises an endoscope. FIG. 26 is a schematic diagram of a device for achieving super-resolution microscopic imaging by a super-oscillatory diffractive neural network according to an embodiment of the present disclosure. As shown in FIG. 26, the device further comprises an optical fiber 2610, a reflective structure 2620, and a detection structure 2630. A super-oscillatory diffractive neural network 2640 is provided in the optical fiber 2610.

The optical fiber 2610 is configured to transmit incident light generated by a light source. Optionally, a holder 2611 is provided on the optical fiber 2610 to fix the super-oscillatory diffractive neural network 2640 by the holder.

The reflective structure 2620 is arranged at an output end of the super-oscillatory diffractive neural network 2640 to reflect an output optical field of the super-oscillatory diffractive neural network 2640, thereby acquiring a reflected signal of a super-oscillatory focal spot.

The detection structure 2630 is arranged on an input end side at an exit end of the optical fiber to detect the reflected signal on a detection plane to acquire an imaging result.

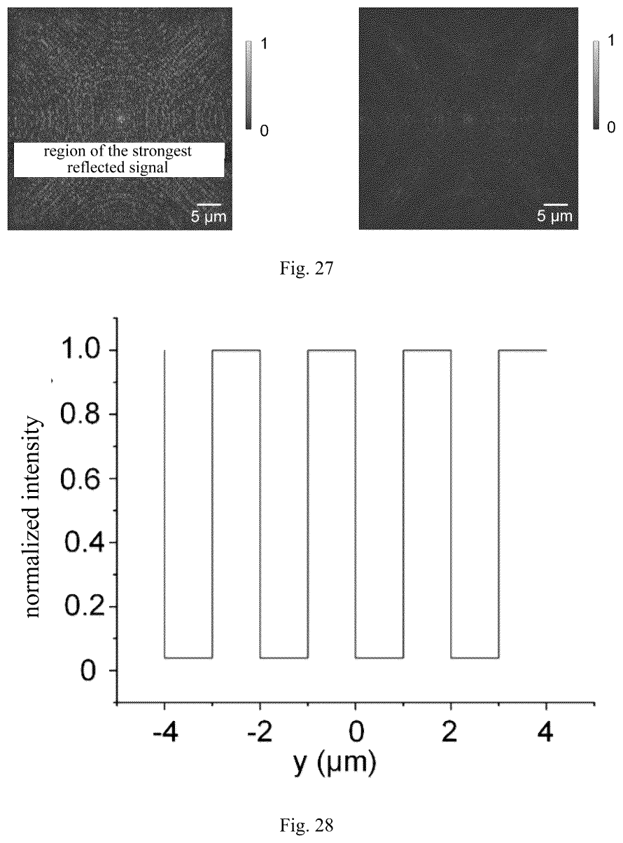

The imaging results of the above endoscope are shown in the red circle in the left part of FIG. 27, where a metal structure produces strong reflection with normalized light intensity of 1. As shown in the right part of FIG. 27, glass produces weak reflection with normalized light intensity of approximately 0. Assuming that the reflective structure 2520 is a resolution test plate, binary changes in light intensity may be used to reconstruct the 500-line-pair pattern on the resolution test plate, thus acquiring an imaging result as shown in FIG. 28.

In summary, according to the method and device for achieving super-resolution microscopic imaging using the super-oscillatory diffractive neural network provided by the present disclosure, by optimizing the diffractive layer with the three-dimensional spatial optical field constraints under the condition of an incident wavelength of λ, a super-oscillatory focal spot with zero side lobes, a large field of view, and a full width at half maximum of 0.407λ may be achieved at a far-field distance greater than 400λ, which also has a long depth of field greater than 10λ. Furthermore, the SODNN also achieves multi-wavelength focusing and multi-wavelength multi-focus arrays, effectively eliminating chromatic aberration. Additionally, the SODNN may operate at any wavelength ranging from microwaves to ultraviolet light, allowing for the acquisition of the super-oscillatory point with a smaller bandwidth, thereby further improving the resolution of imaging by the SODNN. The acquired SODNN may inspire the development of intelligent optical instruments and promote cross-applications in fields such as imaging, sensing, and intelligent perception.

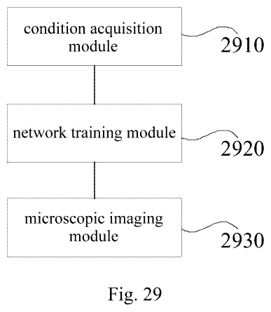

FIG. 29 is a block diagram of a device for achieving super-resolution microscopic imaging by a super-oscillatory diffractive neural network provided by an embodiment of the present disclosure. The device at least comprises a condition acquisition module 2910, a network training module 2920, and a microscopic imaging module 2930.

The condition acquisition module 2910 is configured to acquire three-dimensional optical field constraint conditions. The three-dimensional optical field constraint conditions include a first constraint condition and/or a second constraint condition, the first constraint condition being configured to indicate that within a desired three-dimensional optical field spatial range, a difference of a light intensity distribution of a super-oscillatory focal spot and a light intensity distribution of side lobes from a light intensity distribution of an ideal output optical field is minimized, and the second constraint condition being configured to indicate that within the desired three-dimensional optical field spatial range, light intensity outside a super-oscillatory region is minimized;

the network training module 2920 is configured to train a super-oscillatory diffractive neural network based on the three-dimensional optical field constraint conditions to optimize a step height of a diffractive unit in the super-oscillatory diffractive neural network, to acquire a trained super-oscillatory diffractive neural network, wherein the super-oscillatory diffractive neural network comprises at least one diffractive layer, each of which comprises a plurality of diffractive units; and

the microscopic imaging module 2930 is configured to modulate incident light based on the trained super-oscillatory diffractive neural network to generate a super-oscillation effect in a three-dimensional space to acquire a super-resolution microscopic imaging result.

For further details, please refer to the above embodiments.

In some embodiments, the functions of or the modules included in the devices provided by the embodiments of the present disclosure may be used to carry out the methods described in the above method embodiments, the specific implementation of which may refer to the description of the above method embodiments and will not be repeated herein for the sake of brevity.

An embodiment of the present disclosure further provides a computer readable storage medium having computer program instructions stored thereon, wherein the computer program instructions, when executed by a processor, implement the methods described above. The computer readable storage medium may be a transitory or a non-transitory computer readable storage medium.

An embodiment of the present disclosure further provides an electronic apparatus, comprising: a processor; and a storage for storing processor executable instructions, wherein the processor is configured to, when executing the instructions stored in the storage, implement the methods described above.

An embodiment of the present disclosure further provides a computer program product comprising computer readable code, or a non-transitory computer readable storage medium carrying computer readable code, wherein when the computer readable code runs in a processor of an electronic apparatus, the processor of the electronic apparatus implements the methods described above.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A method for achieving super-resolution microscopic imaging by a super-oscillatory diffractive neural network, comprising:
acquiring three-dimensional optical field constraint conditions, wherein the three-dimensional optical field constraint conditions comprise a first constraint condition and/or a second constraint condition, the first constraint condition to indicate that within a desired three-dimensional optical field spatial range, a difference between a light intensity distribution of a super-oscillatory focal spot and a light intensity distribution of side lobes from a light intensity distribution of an ideal output optical field is minimized, and the second constraint condition to indicate that within the desired three-dimensional optical field spatial range, light intensity outside a super-oscillatory region is minimized;
training a super-oscillatory diffractive neural network based on the three-dimensional optical field constraint conditions to optimize a step height of a diffractive unit in the super-oscillatory diffractive neural network, to acquire a trained super-oscillatory diffractive neural network, wherein the super-oscillatory diffractive neural network comprises at least one diffractive layer, each of which comprises a plurality of diffractive units; and
modulating incident light based on the trained super-oscillatory diffractive neural network to generate a super-oscillation effect in a three-dimensional space, to acquire a super-resolution microscopic imaging result.

2. The method according to claim 1, wherein the three-dimensional optical field constraint conditions comprise the first constraint condition and the second constraint condition, an expression of the three-dimensional optical field constraint conditions comprising:
$${min}_{Δ H} ( {\sum }_{{z}_{i} ∈ [ f - Δ f , f + Δ f ]} \{ {( ( {I}_{( {x}_{i} , {y}_{i} , {z}_{i} )} + {I}_{{\sum }_{j} ( {x}_{j} , {y}_{j} , {z}_{\text{?}} )} ) - {I}_{target} )}^{2} + MSE ( {I}_{( x , y , z ) ∉ ( {x}_{i} , {y}_{i} , {z}_{\text{?}} )} ) \} ) ,$$
$$\text{?} \text{indicates text missing or illegible when filed}$$
wherein min( ) represents a minimization function, ΔH represents a step height distribution of the diffractive units, [f−Δf, f+Δf] represents the three-dimensional optical field spatial range, f represents a focal length, zᵢ represents a distance between the diffractive layer and an output plane, I₍ₓ_{ᵢ}_{,y}_{ᵢ}_{,z}_{ᵢ}₎ represents the light intensity distribution of the super-oscillatory focal spot at three-dimensional spatial coordinates (xᵢ, yᵢ, zᵢ), I_{Σ}_{ⱼ}₍ₓ_{ⱼ}_{,y}_{ⱼ}_{,z}_{ⱼ}₎ represents the light intensity distribution of the side lobes at a set Σⱼ(xᵢ, yᵢ, zᵢ) of the three-dimensional spatial coordinates, I_{target} represents an ideal light intensity distribution of the super-oscillatory focal spot, MSE( ) represents a mean square error function, and I_{(x, y, z)∉}(xᵢ,yᵢ,zᵢ) represents the light intensity outside the super-oscillatory region.

3. The method according to claim 2, wherein a value of the Δf is not equal to zero.

4. A device for achieving super-resolution microscopic imaging by a super-oscillatory diffractive neural network, comprising:
a super-oscillatory diffractive neural network configured to modulate incident light to generate a super-oscillation effect in a three-dimensional space, wherein the super-oscillatory diffractive neural network comprises at least one diffractive layer, each of which comprises a plurality of diffractive units; and step heights of the diffractive units are acquired from training based on preset three-dimensional optical field constraint conditions, the three-dimensional optical field constraint conditions comprising a first constraint condition and/or a second constraint condition, the first constraint condition to indicate that within a desired three-dimensional optical field spatial range, a difference between a light intensity distribution of a super-oscillatory focal spot and a light intensity distribution of side lobes from a light intensity distribution of an ideal output optical field is minimized, and the second constraint condition to indicate that within the desired three-dimensional optical field spatial range, light intensity outside a super-oscillatory region is minimized.

5. The device according to claim 4, wherein a number of the diffractive layers is one.

6. The device according to claim 5, wherein a number of the diffractive units in one diffractive layer is greater than or equal to 500×500.

7. The device according to claim 4, wherein a size of the diffractive units is λ/2×λ/2, λ being a wavelength of the incident light.

8. The device according to claim 4, wherein the device for super-resolution microscopic imaging comprises a reconfigurable apparatus comprising a plurality of the super-oscillatory diffractive neural network, wherein three-dimensional spatial coordinates of super-oscillatory focal spots formed by different super-oscillatory diffractive neural networks are different.

9. The device according to claim 4, wherein the device for super-resolution microscopic imaging comprises an endoscope, and accordingly, the device further comprises:
an optical fiber configured to transmit incident light generated by a light source, the super-oscillatory diffractive neural network being provided in the optical fiber;
a reflective structure arranged at an output end of the super-oscillatory diffractive neural network to reflect an output optical field of the super-oscillatory diffractive neural network to acquire a reflected signal of a super-oscillatory focal spot; and
a detection structure arranged on an input end side at an exit end of the optical fiber to detect the reflected signal on a detection plane to acquire an imaging result.

10. A device for achieving super-resolution microscopic imaging by a super-oscillatory diffractive neural network, comprising:
a processor; and
a storage for storing processor executable instructions,
wherein when executing the instructions stored in the storage, the processor is caused to perform operations of:
acquiring three-dimensional optical field constraint conditions, wherein the three-dimensional optical field constraint conditions comprise a first constraint condition and/or a second constraint condition, the first constraint condition to indicate that within a desired three-dimensional optical field spatial range, a difference between a light intensity distribution of a super-oscillatory focal spot and a light intensity distribution of side lobes from a light intensity distribution of an ideal output optical field is minimized, and the second constraint condition to indicate that within the desired three-dimensional optical field spatial range, light intensity outside a super-oscillatory region is minimized;
training a super-oscillatory diffractive neural network based on the three-dimensional optical field constraint conditions to optimize a step height of a diffractive unit in the super-oscillatory diffractive neural network, to acquire a trained super-oscillatory diffractive neural network, wherein the super-oscillatory diffractive neural network comprises at least one diffractive layer, each of which comprises a plurality of diffractive units; and
modulating incident light based on the trained super-oscillatory diffractive neural network to generate a super-oscillation effect in a three-dimensional space, to acquire a super-resolution microscopic imaging result.

11. A non-transitory computer readable storage medium having computer program instructions stored thereon, wherein when the computer program instructions are executed by a processor, the processor is caused to perform operations of:
acquiring three-dimensional optical field constraint conditions, wherein the three-dimensional optical field constraint conditions comprise a first constraint condition and/or a second constraint condition, the first constraint condition to indicate that within a desired three-dimensional optical field spatial range, a difference between a light intensity distribution of a super-oscillatory focal spot and a light intensity distribution of side lobes from a light intensity distribution of an ideal output optical field is minimized, and the second constraint condition to indicate that within the desired three-dimensional optical field spatial range, light intensity outside a super-oscillatory region is minimized;
training a super-oscillatory diffractive neural network based on the three-dimensional optical field constraint conditions to optimize a step height of a diffractive unit in the super-oscillatory diffractive neural network, to acquire a trained super-oscillatory diffractive neural network, wherein the super-oscillatory diffractive neural network comprises at least one diffractive layer, each of which comprises a plurality of diffractive units; and
modulating incident light based on the trained super-oscillatory diffractive neural network to generate a super-oscillation effect in a three-dimensional space, to acquire a super-resolution microscopic imaging result.
